(19) United States
(12) Patent Application Publication
(10) Pub. No.: US 2013/0061268 A1
(43) Pub. Date: Mar. 7, 2013

(54) SYSTEMS, DEVICES, AND METHODS FOR INTEGRATED SEARCHING AND RETRIEVING INTERNET OR DIGITAL CONTENT ACROSS A COMMUNICATION NETWORK FOR A MULTIMEDIA PLATFORM

(71) Applicant: Leigh M. Rothschild, Sunny Isles Beach, FL (US)

(72) Inventor: Leigh M. Rothschild, Sunny Isles Beach, FL (US)

(73) Assignee: ARIEL INVENTIONS LLC, Sunny Isles Beach, FL (US)

(21) Appl. No.: 13/286,197

(22) Filed: Oct. 31, 2011

Related U.S. Application Data
(60) Provisional application No. 61/530,970, filed on Sep. 3, 2011.

(51) Int. Cl. H04N 21/472; H04N 21/4782

(52) U.S. Cl. 725/51; 725/53

(57) ABSTRACT

Systems, methods and devices for searching and retrieving content across a communication network are disclosed. They may include a display, one or more input receivers, and a multimedia processing unit as well as an input device and one or more remote computer servers. Embodiments include receiving configuration information for the multimedia system to search for related content during the display of viewed content using the input receivers and cause the viewed content to be displayed on the one or more display components. Further embodiments identify one or more objects in the viewed content and search one or more information repositories for the related content based on the one or more objects. Additional embodiments access the related content from the one or more information repositories and cause to display the related content on the display of a multimedia system.

### CROSS-REFERENCE TO RELATED APPLICATIONS

The present application claims priority under the laws and rules of the United States, including 35 USC §120, to U.S. Provisional Patent Application No. 61/530,970 filed on Sep. 3, 2011. The contents of U.S. Provisional Patent Application No. 61/530,970 are herein incorporated by reference.

### BACKGROUND

Smart television environments are beginning to emerge as a multimedia platform/system for consumers/users to view and enjoy both television content as well as accessing Internet content or other digital content (e.g. DVD, Blu Ray disc, etc.) simultaneously. The Internet content may be streaming video content, an information website (e.g. blog, news, reference, etc.), or an e-commerce site. Digital content may be content that is stored locally with the multimedia system or at remote site and/or is played on the multimedia system. This allows consumers to have a more robust entertainment experience that can span multiple types of media. For example, the smart television environment may be capable of having the consumer view television content and the Internet/digital content in a picture-in-picture mode. Such smart television systems may have several components and providers including a developer of the multimedia platform/system and the underlying operating system, the vendor for the user interface or Internet/web browser, the television content provider (e.g. cable operator, satellite operator, etc.), Internet service provider, hardware manufactures for the television, blu-ray disc player, set-top box, and/or DVR as well as other local storage devices. Navigating the different technologies and components provided by the different entities may be cumbersome to a consumer using such a multimedia platform in a smart television environment.

### BRIEF SUMMARY

There are several smart TV platforms such as Google TV and Tivo Premiere that provide a user with different types and ways to view media through a television. For example, such smart TV platforms may allow a user to search for a program, actor, movie, video, or other digital content as well as find search terms for the smart TV platform to search for related web content. Further, the smart TV platform may provide access to movies, television programs, and web content (web videos, websites, etc.) related to the media content currently viewed by the user. In addition, the user can access different applications to view different media content such as YouTube, Netflix, Hulu, etc.

However, smart TV platforms do not currently provide a user the ability to select and access certain content currently viewed by the user. For example, if a television program stars Brad Pitt and Brad Pitt is wearing a suit and holding a suitcase in a particular scene, current smart TV platforms may be able to determine the that the show stars Pitt and may provide related Brad Pitt television programs and movies as well related Brad Pitt digital content and may even provide a user with video on demand, available DVDs, and websites etc. related to Brad Pitt. However, current smart TV platforms do not recognize the suit that Pitt is wearing, or a supporting character that is in the media content with Brad Pitt (an uncredited character in this example) or the bedspread that Pitt is using. Aspects of the present disclosure provide solutions to such deficiencies in current smart TV platforms and evolve such technology in new, different, and unforeseen avenues with respect to the current state of the art.

Embodiments of the disclosure include systems, methods, and devices for integrated searching and retrieving Internet or digital content across a communication network using a multimedia system. Such embodiments may include a consumer viewing a television program. The consumer/viewer may then conduct a search for Internet content related to the television program through a user interface. For example, the user interface or input receiver may include a microphone and voice recognition technology that would allow the viewer to conduct a search by speaking one or more search terms. An embodiment may include speaking the name of the main actor of the television program as the search term. The multimedia system and its associated and related components may then search the Internet for websites relating to the main actor. This may include displaying a selection of other television programs and movies the actor played a role in, information/gossip website that discuss aspects of the actor's life, and e-commerce websites that may allow the consumer to purchase DVDs of movies or programs starring the actor. The television program may be an on-demand movie provided by the consumer's cable operator and the retrieved digital content may be a trailer of an upcoming movie starring the actor, the trailer stored on a cable operator's remote site. The Internet/digital content may be shown in full screen or in picture-in-picture mode so that the consumer may continue to view the television program while also accessing the Internet content.

Further embodiments may include a software operating system as part of a software/hardware multimedia platform. Such embodiments may recognize certain media content using one or more software applications that processes the media content. Further, the software applications may process the media content to determine the media type and any objects contained, saved, or displayed in the media content including articles of commerce and/or persons featured in the content (e.g. actor in a movie, product in a commercial, product in a scene of a television program etc.). Further, the multimedia platform allows a user to request information or ancillary media content related to such articles of commerce, content, or persons identified/selected.

Additional embodiments may include the clicking of a remote control associated to the multimedia platform as an input to the multimedia platform. Further embodiments may include that the multimedia platform is configured before viewing television content such that with one click of a button on a remote control, a keyboard, or alternatively, a spoken word uttered by the consumer while viewing a television program may cause the multimedia platform to access Internet content related to the television program that may include streaming video content of movies and television programs with similar themes to the currently viewed television program as well as video content that includes the same actors as in the currently viewed television program. In addition, the multimedia platform may access an information website related to the television program and its actors such as entertainment news websites, gossip websites, etc. Also, e-commerce websites may be accessed and displayed on the television related to currently viewed television program such as DVDs of the currently viewed television program, DVDs of actors of the currently viewed television program, as well as any other merchandise. For example, a cartoon movie may have several popular characters such that e-commerce websites have stuffed animal toys of the main characters. In another example, the consumer may select the suit worn by an actor in a particular scene and request a search of e-commerce website where the consumer may purchase the suit.

Other embodiments may include the multimedia platform store official content (e.g. official or authorized website) related to a popularly viewed television programs to be viewed by the consumer when it indicates (through speech, click of an input device or simply turning on a television program) because the multimedia program is preconfigured to provide related Internet content to the television program. For example, the multimedia may analyze a consumer's watching habits as well as analyze the DVR associated with the multimedia platform. Thus, if such a television program is viewed again, the multimedia platform may cause a trailer or official website for the television program to be displayed on the television either in full screen mode or picture-in-picture.

Further embodiments may include indicating that an Internet search be performed or Internet/digital content be accessed by the multimedia platform relating to the television content currently being viewed by the consumer. However, instead of displaying the Internet Search results or the Internet content simultaneously with the television program, the multimedia platform saves the Internet Search results or the Internet/digital content to be viewed later by the consumer. The saved Internet Search results or Internet content may be saved in a DVR device or any other storage device associated with the multimedia platform. Alternative embodiments may allow a consumer to indicate the multimedia platform to conduct Internet searches or access Internet content during various times of the television program or during the viewing of several television programs. Such plurality of Internet Search results and Internet/digital content may also be saved in a DVR or other storage device associated with the multimedia platform. The Internet search results and accessed Internet/digital content are stored in an organized manner and identified in such a manner that they relate to the television program viewed during the time the consumer indicated to perform the Internet Search or access the Internet/digital content.

Additional embodiments include the capability of a consumer to view Internet or locally/remotely stored digital content related to a currently or previously viewed television program and send the Internet or locally/remotely stored digital content to one or more people through various methods known in the art including but not limited to emailing, sharing via one or more social media websites, or texting the Internet content or a link to the Internet content. Also, the consumer when viewing the Internet content on his multimedia platform, the multimedia platform may indicate that the consumer is viewing such Internet content to other viewers on a network of compatible multimedia platforms. Thus, the consumer may share the Internet content with another viewer using a compatible multimedia platform such that the other viewer may see an indication from the consumer to share the consumer's Internet content (e.g. through a pop-up window) and then click the indication to view the shared Internet content. Other embodiments may include sharing the Internet content or transmitting it to another computing device owned or operated by the consumer such as a tablet computer, smartphone, etc. Additional embodiments may include accessing a social media application (e.g. Facebook) on the multimedia platform and then sharing the Internet content through the social media application to other user of the social media platform/application (e.g. other Facebook users).

Other embodiments may include a consumer's ability to use functions of the multimedia platform to filter one or more Internet searches and search results performed and related to a viewed television program as well as filter the accessible Internet content. For example, the consumer may only want view e-commerce websites related to the television program. Another example is that the consumer would like to view only blogs related to an actor in the television program.

Persons of ordinary skill in the art would understand that television programming content or television content may refer to not only television programs broadcast on network television, broadcast television, cable television, satellite television, etc. but also any program or content view on a television that may include but not limited to streaming video content from a cable operator or from across the Internet, on-demand video, gaming, or any other content accessible from the Internet, Internet provider, cable operator, or satellite television service provider.

Embodiments of the present disclosure may include a method for searching and retrieving content across a communication network using a multimedia system. Such an exemplary method may include a step for configuring the multimedia system to search for related content during the display of viewed content and a further step for displaying the viewed content on the multimedia system. An additional step may be identifying one or more objects in the viewed content using one or more software applications implemented by the multimedia system. Another step may be searching one or more information repositories for the related content based on the one or more objects and accessing the related content from the one or more information repositories. Additional steps may include displaying the related content on the multimedia system and storing the related content in one or more storage devices. An information repository may be a database or a storage device located either locally as part of the multimedia system or remotely associated or as part of a remote computer server.

Further, the configuring of the multimedia system is performed using an input device. In addition, the one or more objects may be selected from a group consisting of the title of the viewed content, one or more actors in the viewed content, one or more products (e.g. articles of commerce) in the viewed content.

A further step in the exemplary method may include configuring the multimedia system to search for related content prior to the display of viewed content. Also, the related content is selected from the group consisting of digital content and Internet search results and the input device are selected from the group consisting of remote control, keyboard, mouse, voice activation, gesture activation, and smartphone.

Embodiments of the present disclosure may include a multimedia system for searching and retrieving content across a communication network. Such a multimedia (MM) system may include one or more display components, one or more input receivers and a MM processing unit coupled to the one or more display components and to the one or more input receivers. The MM processing unit may have one or more processors, one or more storage devices coupled to the one or more processors, one or more communication interfaces, a first communication interface coupled to the one or more processors and a second communication interface coupled to the communication network, and one or more software applications. Further the software applications may implement one or more functions that include receiving configuration information for the MM system to search for related content during the display of viewed content using the one or more input receivers. Another software function may be causing the viewed content to be displayed on the one or more display components and identifying/selecting one or more objects in the viewed content. Additional software functions may be searching one or more information repositories for the related content based on the one or more objects, accessing the related content from the one or more information repositories, and causing to display the related content on the MM system.

The exemplary system may also include one or more digital storage devices wherein the one or more software applications store the related content in the one or more digital storage devices and one or more input receivers to receive the configuration information for the MM system.

Further, the one or more objects may be selected from a group consisting of the title of the viewed content, one or more actors in the viewed content, or one or more products in the viewed content. In addition, the configuration information is provided to the MM system prior to the display of viewed content and the related content is selected from the group consisting of digital content and Internet search results. Also, the one or more input receivers are capable of receiving user input from an input method selected from the group consisting of remote control, keyboard, mouse, voice activation, gesture activation, and smartphone.

Embodiments of the disclosure include an exemplary MM system for searching and retrieving content across a communication network. Such an exemplary system may include a communication network, one or more remote computer servers coupled to the communication network, an input device, and a MM processing unit coupled to one or more display components and to one or more input receivers. The MM processing unit may include one or more processors, one or more storage devices coupled to the one or more processors, one or more communication interfaces, a first communication interface coupled to the one or more processors and a second communication interface coupled to the communication network, and one or more software applications. Further, the one or more software application may implement one or more software functions that include receiving configuration information for the MM system to search for related content during the display of viewed content from the input device and causing the viewed content to be displayed on the one or more display components. Additional software functions may be identifying/selecting one or more objects in the viewed content and searching one or more information repositories for related content based on the one or more objects. Other software functions may be accessing the related content from the one or more information repositories and causing to display the related content on the MM system.

In addition, the one or more remote computer servers are selected from the group consisting of a search engine server, a web server, a content server, and an e-commerce server. Further, the exemplary system may include one or more digital storage devices wherein the one or more software applications store the related content in the one or more digital storage devices. Also, the configuration information is provided to the MM system prior to the display of the viewed content and the related content is selected from the group consisting of digital content, Internet search results, and e-commerce transaction form. In addition, the one or more input receivers are capable of receiving user input from an input method selected from the group consisting of remote control, keyboard, mouse, voice activation, gesture activation, and smartphone.

The foregoing summary is illustrative only and is not intended to be in any way limiting. In addition to the illustrative aspects, embodiments, and features described above, further aspects, embodiments, and features will become apparent by reference to the drawings and the following detailed description

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presently preferred, it being understood, however, that the present disclosure is not limited to the precise arrangements and instrumentalities shown, wherein:

FIG. 1 is an exemplary system for integrated searching and retrieving Internet or digital content across a communication network for an exemplary multimedia system;

FIG. 2 is an exemplary functional block diagram of an exemplary multimedia system for integrated searching and retrieving Internet or digital content across a communication network;

FIG. 3 is an exemplary functional block diagram of an exemplary multimedia processing unit used for integrated searching and retrieving Internet or digital content across a communication network for an exemplary multimedia system;

FIG. 4 is an exemplary functional block diagram of an exemplary computer server used for integrated searching and retrieving Internet or digital content across a communication network for an exemplary multimedia system;

FIG. 5 is an exemplary functional block diagram of an exemplary input device used for integrated searching and retrieving Internet or digital content across a communication network for an exemplary multimedia system;

FIG. 6 is an exemplary flowchart showing an example method for integrated searching and retrieving Internet or digital content across a communication network for an exemplary multimedia system.

### DETAILED DESCRIPTION

In the following detailed description, reference is made to the accompanying drawings, which for a part hereof. In the drawings, similar symbols typically identify similar components, unless context dictates otherwise. The illustrative embodiments described in the detailed descriptions, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written descriptions. While these details are helpful to explain one or more embodiments of the disclosure, those skilled in the art will understand that these specific details are not required in order to practice the embodiments.

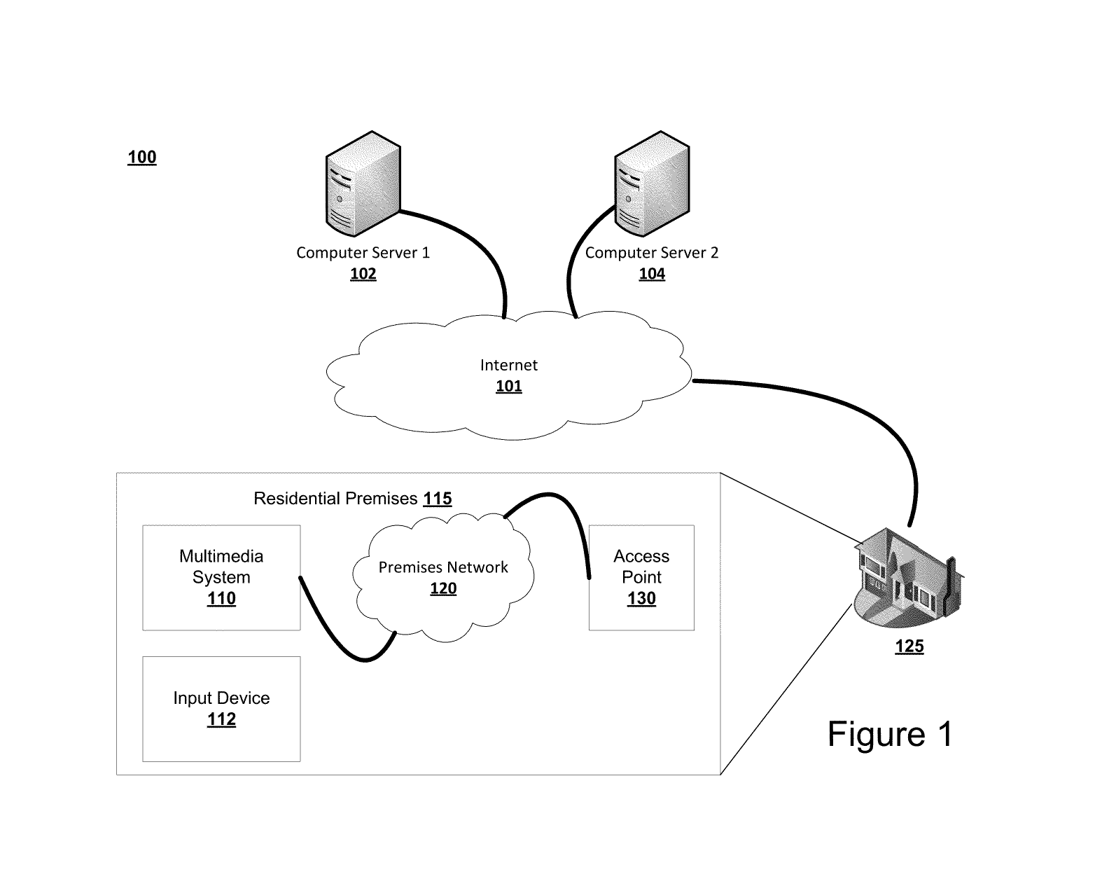

FIG. 1 is an exemplary system 100 for integrated searching and retrieving Internet or digital content across a communication network 101 for an exemplary MM system 110. The communication network 101 may be the Internet or some other network (e.g. WiFi, Ethernet, Cellular, etc.). The MM system 110 may be located on residential premises 115 in a user residence 125. Further, the MM system 110 may access a premises network 120 which may be, for example, a WiFi, Ethernet, or some other network known in the art. Further, an access point 130 may also be coupled to the premises network 120. In addition, the access point 130 may be coupled to the Internet 101. Thus, the MM system 110 may access the Internet 101 through the premises network 120 and the access point 130. Further, the MM system 110 may be configured or otherwise controlled by an input device 112 or user interface. An example of an input device may include a remote control as may be used to control a television, DVD player, etc. A further example may be a voice recognition system that may be used to configure the MM system 110. In such an embodiment, the voice recognition device may not be a separate device apart from the MM system 110 but instead may be a component integrated in such a MM system 110. Other components in the exemplary system showed in FIG. 1 may include one or more computer servers. Computer server 1 (102) may be a server that is owned and operated by a content provider and is capable of streaming video or other digital content to the MM system 110. Alternatively, computer server 2 (104) may be an e-commerce sever that provides the capability of purchasing items (e.g. articles of commerce) pictured in the digital content viewed on the MM system 110.

Embodiments of the exemplary system shown in FIG. 1 may include a consumer viewing digital content such as a television program and then conducting a search for Internet content related to the television program through an input device or user interface 112. For example, the input device 112 may include a microphone and voice recognition technology that would allow the viewer to conduct a search by speaking one or more search terms. In certain embodiments the input device 112 may be separate from the MM system 110 as in a remote control, keyboard or mouse. Other embodiments the input device may be more closely coupled to the MM system 110 such as voice action technology, touch screen, and gesture activation. An embodiment may include speaking the name of the main actor of the television program as the search term. The MM system 110 and its associated and related components may then search the Internet for websites relating to the main actor. This may include displaying selection of other television programs and movies the actor played a role, information/gossip website that discuss aspects of the actor's life, and e-commerce websites (e.g. computer server 104) that may allow the consumer to purchase DVDs of movies or programs starring the actor. The television program may be an on-demand movie provided by the consumer's cable operator and the retrieved digital content may be a trailer stored on a cable operator's remote server such as Computer 1 102. The Internet/digital content may be shown in full screen or in picture-in-picture mode so that the consumer may continue to view the television program while also accessing the Internet content.

Further embodiments may include a software operating system as part of the MM system 110. Such embodiments may recognize certain media content using one or more software applications that processes the media content. Further, the software applications may process the media content to determine the media type and any objects contained, saved, or displayed in the media content including articles of commerce and/or persons featured in the content (e.g. actor in a movie, product in a commercial or in a scene of a television program, movie, or Internet video, etc.). Further, the MM system 110 allows a user to request information or ancillary media content related to such articles of commerce, content, or persons identified.

Additional embodiments of the exemplary system 100 may include the clicking a remote control as an input device 112 associated to the MM system 110. Further embodiments may include that the MM system 110 is configured before viewing television content such that with one click of a button on a remote control or a keyboard, or alternatively, a spoken word uttered (all which are embodiments of input device 112) by the consumer viewing a television program may cause the MM system 110 to access Internet content related to the television program that may include streaming video content of movies and television programs with similar themes to the currently viewed television program as well as video content that includes the same actors as in the currently viewed television program. In addition, the MM system 110 may access an information website related to the television program and its actors such as entertainment news websites, gossip websites, etc. Also, an e-commerce web server 104 may be accessed and displayed on the television related to currently viewed television program such as DVDs of the currently viewed television program, DVDs of actors of the currently viewed television program, as well as any other merchandise related to the content. For example, a cartoon movie may have several popular characters such that an e-commerce web server 104 offers stuffed animal toys of the main characters.

Other embodiments may include the MM system 110 store official content (e.g. official or authorized website) related to a popularly viewed television programs to be viewed by the consumer when it indicates (through speech, click of an input device or simply turning on a television program) because the MM system 110 is preconfigured to provide related Internet content to the television program. For example, the MM may analyze a consumer's watching habits as well as analyze the DVR associated with the MM system 110. Thus, if such a television program is viewed again, the MM system 110 may cause a trailer or official website for the television program to be displayed on the television either in full screen mode or picture-in-picture.

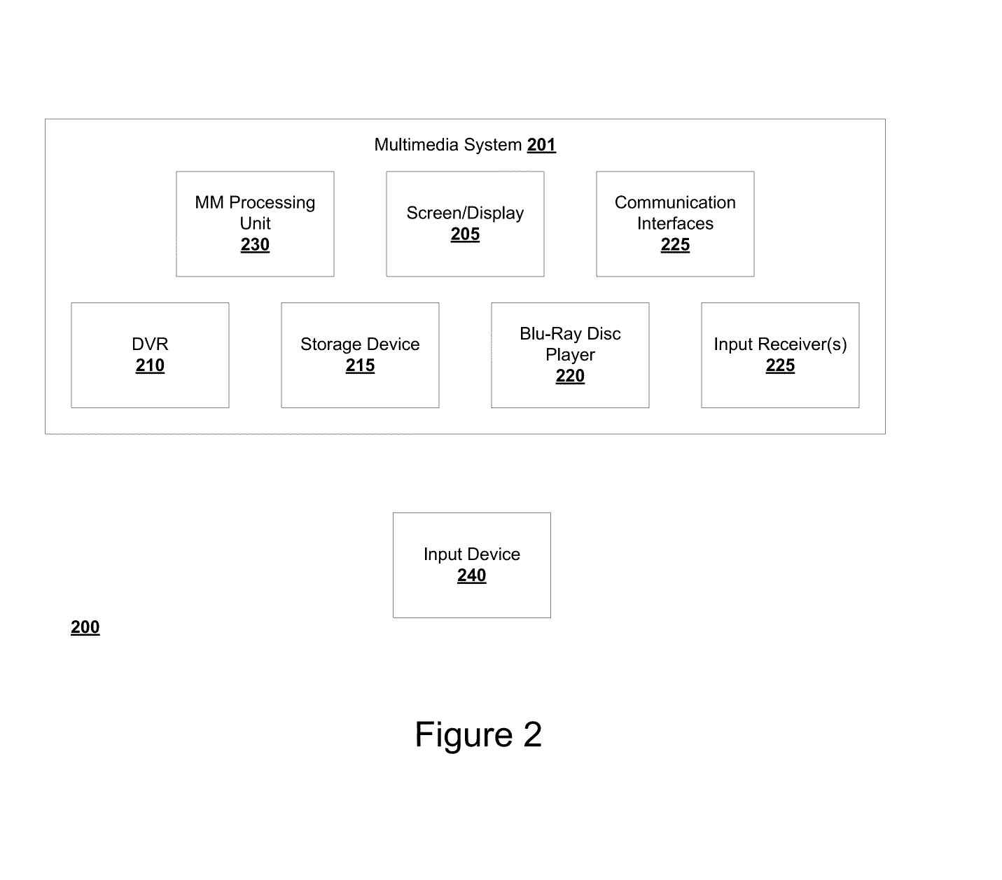

FIG. 2 is an exemplary functional block diagram 200 of a MM system 201 for integrated searching and retrieving Internet or digital content across a communication network. The MM system 201 may include several components including a MM processing unit 230, a screen or display 205, one or more communication interfaces 225, a digital video recorder (DVR) 210, one or more storage devices 215, a Blu-ray disc player 220 and one or more input receivers 225. The MM processing unit 230 may include several hardware and software components that include, but are not limited to, one or more processors, one or more storage devices, one of more software applications, and one or more communication interfaces. The screen or display 205 may be a liquid crystal display (LCD) screen used in traditional flat screen televisions and laptop, notebook, desktop, or tablet computers. Further, the display 205 may incorporate touchscreen functionality such that it is an input receiver in addition to other input receivers 225. In addition, the display 205 may be incorporate standard definition, high definition or three-dimensional (3D) technology. Further, the display 205 may be capable of detecting signals from a remote control input device that allows a user to select an object such as an actor or object (e.g. article of commerce) viewed on the display 205. For example, through the motion/gesturing of the remote control from a user to place a box around the head of an actor, the display may show the selected portion of the content and then cause the MM system to determine from the selected image/content the identity of the actor and search for related content accordingly. Further, if a user boxes an article of commerce within the display image/digital content, the MM system may determine identity of the object and search for related content accordingly. In other embodiments, the input receiver may incorporate voice recognition technology such that the user may identify an article of commerce viewed in a scene of a display television program (e.g. “car in scene”) such that the MM system 201 identifies the article of commerce (e.g. 2011 Porsche 911) and performs a search for Internet content related to the article of commerce.

The communication interfaces 225 may be a WiFi interface, Ethernet interface, cellular or other communication interfaces known in the art. The DVR 210 may be a storage device for digital content such that the digital content is television program broadcasted by the user's cable or satellite television provider. Alternate embodiments may have the DVR 210 to be manufactured and at least partially controlled and operated by a third party provider (e.g. TiVo). The exemplary MM system 201 may also include one or more storage devices for digital content and/or Internet search results. Such a storage device may incorporate any storage medium known in the art such as hard disk drive (internal or external) optical storage, flash, RAM, DRAM, DVD drive, Blu-Ray disc drive, and others. The Blu-ray disc player 220 may also be a part of the exemplary MM system 201 such that digital content played on the Blu-ray Disc player 220 may be viewed by a user on the screen/display 205. Alternate embodiments of the MM system 201 may include other digital content playing devices such as DVD players as well as laptop, notebook, desktop, or tablet computers. Input receiver(s) 225 may include a detector that receives electronic, optical, or infrared signals from a remote control input device 240. Other embodiments of the input receiver(s) 225 may include a speech recognition technology such that voice input from the user may be received. Such speech recognition technology may include a microphone to detect user voice input. In addition, one or more input devices 240 may be used to configure and control the MM system 201. Such input devices may include a remote control similar to traditional remote control devices associated with conventional SD, HD, and 3D televisions. Other input devices may include a mouse or keyboard input device. In addition, a smartphone may be configured as input device to control the MM system 201. The input receiver(s) 225 may be separate components with the MM system 201 or may be integrated with other components such as the MM processing unit 230 or screen/display 205.

Further embodiments may include a user viewing television content on the MM system 201, and specifically on the screen/display 205. The user may use the input device 240 to indicate that an Internet search be performed or Internet/digital content be accessed by the MM system 201 relating to the television content currently being viewed by the user. In one embodiment, the MM system 201 may display the Internet Search results or the Internet content simultaneously with the television content, either side by side or in picture-in-picture mode. Alternate embodiments may have the user configure the MM system 201 to save the Internet search results or the Internet/digital content to be viewed later by the consumer. The saved Internet search results or Internet content may be saved on DVR 210 or any other storage device 215 associated with the MM system 201. Other embodiments may allow a user to preconfigure the MM system 201 prior to viewing any television content to conduct Internet searches or access Internet content during various times of the television program or during the viewing of several television programs. Such plurality of Internet search results and Internet/digital content may also be saved in a DVR 210 or other digital storage device 215 associated with the MM system 201. The Internet search results and accessed Internet/digital content are stored in an organized manner and identified in such a manner that they relate to the television program viewed during the time the consumer indicated to perform the Internet search or access the Internet/digital content.

Additional embodiments include the capability of a consumer to view Internet content related to a currently or previously viewed television program and send the Internet content to one or more people through various methods known in the art including but not limited to emailing, sharing via one or more social media websites, or texting the Internet content or a link to the Internet content. Also, the consumer when viewing the Internet content on his MM system 201, the MM system 201 may indicate other viewers on a network of compatible MM systems. Thus, the consumer may share the Internet content to another viewer using a compatible MM system such that the other view may see an indication from the consumer to share the consumer's Internet content (e.g. through a pop-up window) and then click the indication to view the shared Internet content. Other embodiments may include sharing the Internet content or transmitting it to another computing device owned or operated by the consumer such as a tablet computer, smartphone, etc.

Other embodiments may include a consumer's ability to use functions of the MM system 201 to filter Internet searches related to a viewed television program as well as filter the accessible Internet content. For example, the consumer may only want view e-commerce websites related to the television program. Another example is that the consumer would like to view only blogs related to an actor in the television program.

Persons of ordinary skill in the art would understand that television programming content or television content may refer to not only television programs broadcast on network television, broadcast television, cable television, satellite television, etc. but also any program or content viewed on a television that may include but not limited to streaming video content from a cable operator or from across the Internet, on-demand video, gaming, or any other content accessible from the Internet, Internet provider, cable operator, or satellite television service provider.

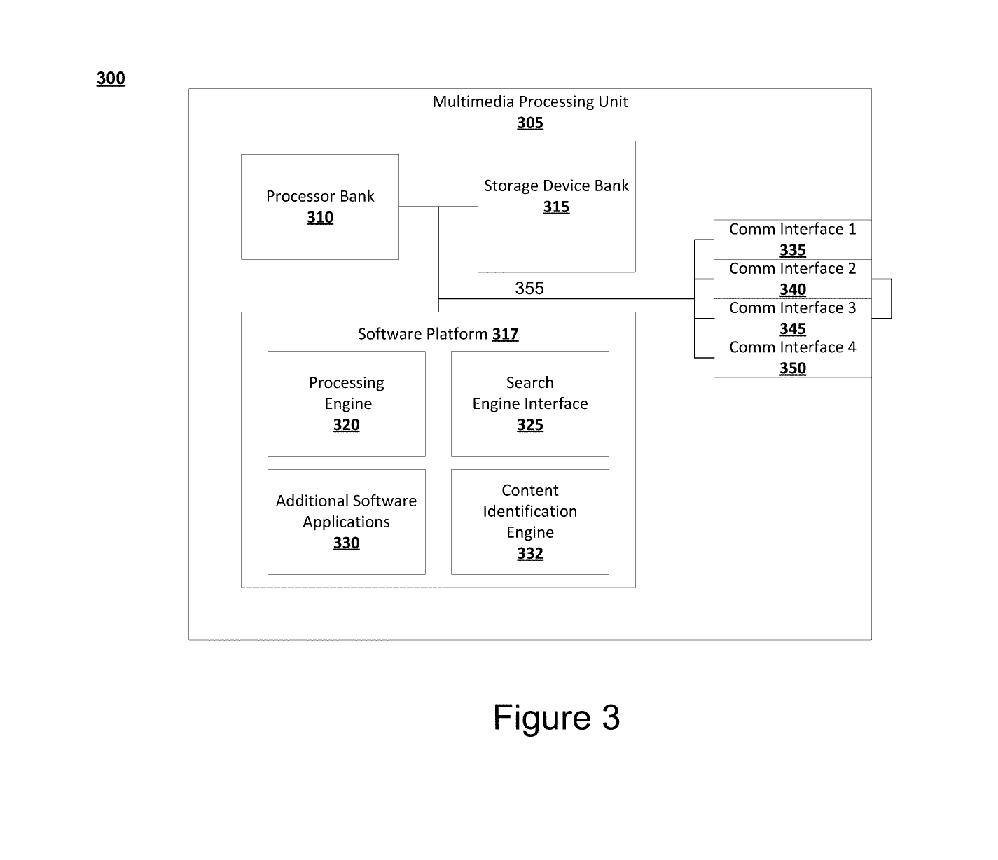

FIG. 3 is an exemplary functional block diagram 300 of an exemplary MM processing unit 305 used for integrated searching and retrieving Internet or digital content across a communication network for an exemplary MM system as shown in FIG. 2. The MM processing unit 305 may include several different components such as a processor bank 310, storage device bank 315, one or more software applications 317, and one or more communication interfaces (335-350). The processor bank 310 may include one or more processors that may be co-located with each other or may be located in different parts of the MM processing unit 305. The storage device bank 315 may include one or more storage devices. Types of storage devices may include memory devices, electronic memory, optical memory, and removable storage media. The one or more software applications 317 may include a processing engine 320, a search engine interface 325, content identification engine 332 and additional software applications 330. The additional software applications may include control software applications that implement software functions that assist in performing certain tasks for the MM processing unit 305 such as providing access to a communication network, executing an operating system, managing software drivers for peripheral components, and processing information. Additional software application may also include software drivers for peripheral components, user interface computer programs, debugging and troubleshooting software tools. Also, the additional software applications may include an operating system supported by the MM processing unit. Such operating systems are known in the art for such an MM system shown in FIG. 2 but may also include computer and smartphone operating systems (e.g. Droid, Symbian, Windows 7, Linux, Windows Mobile, MacOS, etc.).

The search engine interface 325 may cause a software application to be displayed on the screen/display of the MM system such that a user may enter a keyword to search. The search engine interface may then transmit the keyword to processing engine 320 which in turn requests across one of the communication interfaces (335-350) over a communication network to a search engine residing on a remote computer server to perform a search based on the keyword. The search engine may then return a list of Internet search results to processing engine 320 of the MM processing unit 305 across one of the communication interfaces (335-350) over a communication network. The processing engine may then provide the list to the search engine interface 325 or store the Internet Search results in of the storage devices in the storage device bank 315 to be access in the future by the user. According to different embodiments, the search engine interface 325 may access one of the storage devices to retrieve saved Internet results based on user input received from one or more input receivers or receive the Internet search results from the processing engine 320. Further, the search engine interface 325 may then cause the Internet search results to be displayed on the screen/display of the MM system. The Internet Search results may be displayed in a variety of ways that include, but are not limited to, displaying the Internet search results on the entire screen, displaying the Internet search results side by side with the television/digital content being viewed by the user, or displaying the Internet Search results with the television/digital content being viewed by the user in a picture-in-picture mode. Further, the search engine interface 325 may indicate that an identified/selected object (e.g. actor, article of commerce) within the content being viewed on the MM system by the user as the search term has been selected and cause an Internet search to be performed based on such identified/selected object.

The MM processing unit may include a content identification software engine 332 that is aware of the television and/or digital content (streaming from Internet or played by a Blu-ray or DVD player) being viewed by the user on the MM system. If provided instructions (via an input device) to such, the content identification may be used to identify one or more objects including products and articles of commerce within the television content. Thus, the identified object is provided to the processing engine to search the Internet for related content for the viewing of the user as well as causing to the search interface engine 325 to display the search term to the user Content identification may include a user identifying an object within digital content by using the signals transmitted from a remote control device and then selecting the object viewed (e.g. head of an actor or article of commerce in a scene or image of digital content by circling or boxing the image using the signals transmitted from the remote control device). The image of the object (head of actor, article of commerce, etc.) may be provided to the content identification engine 332 and then the content identification engine 332 may perform an image search to determine the identity of the object and then conduct a search of locally and remotely stored content as well as Internet content to find and provide such search results to the user. Alternatively, the input device may incorporate voice recognition technology such that the user may identify an object through speech (“car in scene”). Thus, the content identification engine 332 may identify the car in the scene of the viewed content (e.g. 2011 Porsche 911) and provide such a search term to the processing engine 320 and search interface engine 325. The processing engine 320 may conduct an Internet search with regard to the identified object and the search interface engine 325 may display the identified object/search term to the user on the MM system.

Further, the user may preconfigure the MM system to perform Internet searches for the actors related to the digital content being viewed on the MM system. The preconfiguration may be done by the user through an input device and received by one or more input receivers for the MM system. Further, the input receiver may transmit the user input to the processing engine 320. Thus, for the exemplary embodiment that the MM system is preconfigured to perform an Internet search of the actors related to the viewed digital content, the processing engine 320 may query the content identification engine 332 to retrieve the actor names and then request a remote search engine residing on a remote computer server to perform an Internet search for one or more actors and to return a list of search results accordingly.

In other embodiments the MM system may be preconfigured by the cable or satellite provider and the MM processing unit may be part of a set-top box operated by the cable or satellite provider. Further, the processing engine 320 may be preconfigured to access related content to the television program viewed by the user on the MM system and cause the accessed related content to be displayed on the MM system screen. For example, the user may view a television program with a certain actor. The processing engine 320 queries the content identification engine for actors in the television program. Further, the processing engine 320 is preconfigured to access any trailer stored on the remote server of the cable or satellite provider for a related movie that is available for on-demand from the cable or satellite provider. The user may be notified of such a trailer on the MM system display by the processing engine 320 such that the user may view the trailer immediately or have the trailer saved and viewed after viewing the current television program.

Each of the communication interfaces (335-350) shown in FIG. 3 may be software or hardware associated in communicating to other devices. The communication interfaces (335-350) may be of different types that include a user interface, USB, Ethernet, WiFi, WiMax, wireless, optical, cellular, or any other communication interface coupled to communication network.

An intra-device communication link 355 between the processor bank 310, storage device bank 315, software applications 317, and communication interfaces (335-350) may be one of several types that include a bus or other communication mechanism.

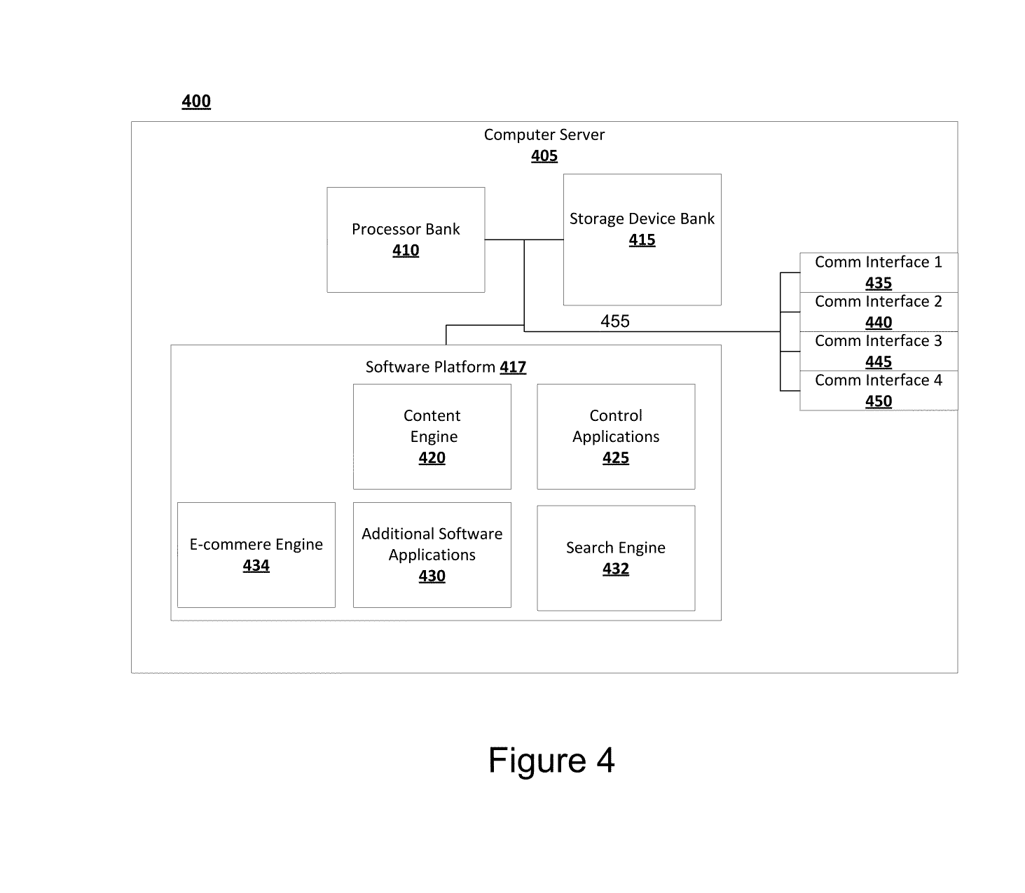

FIG. 4 is an exemplary functional block diagram 400 of an exemplary computer server used for integrated searching and retrieving Internet or digital content across a communication network for an exemplary MM system as shown in FIG. 2. The computer server 405 may include several different components such as a processor bank 410, storage device bank 415, one or more software applications 417, and one or more communication interfaces (435-450). The processor bank 410 may include one or more processors that may be co-located with each other or may be located in different parts of the computer server 405. The storage device bank 415 may include one or more storage devices. Types of storage devices may include memory devices, electronic memory, optical memory, and removable storage media. The one or more software applications 417 may include a content software engine 420, a search software engine 432, e-commerce software engine 434, control software application 425, and additional software applications 430. Depending on the type of computer server 405, all of a subset of software applications 417 may be incorporated in computer server 405. The control software applications 425 may implement software functions that assist in performing certain tasks for the computer server 405 such as providing access to a communication network, executing an operating system, managing software drivers for peripheral components, and processing information. Also, the control software applications 425 may include an operating system supported by the computer server 405. Such operating systems are known in the art but may also include computer (e.g. Windows 7, Linux, MacOS, etc.). Additional software applications 430 may include software drivers for peripheral components, user interface computer programs, debugging and troubleshooting software tools.

In one embodiment, the computer server 405 may be owned or operated by a cable or satellite provider that broadcasts television program to the MM system to be viewed by the user. Further, the computer server 405 may store trailers of on-demand movies offered by the cable or satellite provider. Such trailer content may be stored in the storage bank 415 or in a database or other information repository associated with the computer server 405. In addition, the trailer content may be stored in such a way that the trailer content may be accessed by searching for an actor's name starring in one or more of the on-demand movies. Thus, if the computer server 405 receives an actor's name as a search term, the content engine 420 may cause a search of the trailer content and retrieve any trailer content related to the actor. Further, such trailer content may be transmitted to the MM system by the content engine 420 to be viewed by the user immediately or saved on a storage device of the MM system to be viewed in the future.

In another embodiment, the computer server 405 may receive a keyword or search term from the MM system and cause the search engine 432 to perform an Internet search of the keyword. Further, the search engine 432 may generate a list of search results that include links to websites and other Internet content related to the keyword or search term. Further, such a list of Internet search results may be transmitted to the MM system by the search engine 432 to be viewed by the user immediately or saved on a storage device of the MM system to be viewed in the future.

In an additional embodiment, the computer server may receive a name of a product or article of commerce from a commercial viewed by the user or a name of a product or article of commerce found in a television program. For example, there may be a television commercial for a home gaming system (Wii, Xbox, Play station, etc.). A user may initiate a search for an e-commerce website for such a home gaming system from the MM system. Alternatively, an actor may be driving a specific vehicle in a particular television program. A user viewing the television program may initiate a search of e-commerce websites for the specific vehicle. In addition, the computer server 405 may receive the product name and the e-commerce engine 434 may provide a product description to the MM system to be displayed and viewed by the user. Thereafter, the user may initiate an e-commerce transaction using the MM system (MM process unit and associated processing engine) interacting with the e-commerce engine 434 to complete the purchase transaction of the product.

Each of the communication interfaces (435-450) shown in FIG. 4 may be software or hardware associated in communicating to other devices. The communication interfaces (435-450) may be of different types that include a user interface, USB, Ethernet, WiFi, WiMax, wireless, optical, cellular, or any other communication interface coupled to communication network.

An intra-device communication link 455 between the processor bank 410, storage device bank 415, software applications 417, and communication interfaces (435-450) may be one of several types that include a bus or other communication mechanism.

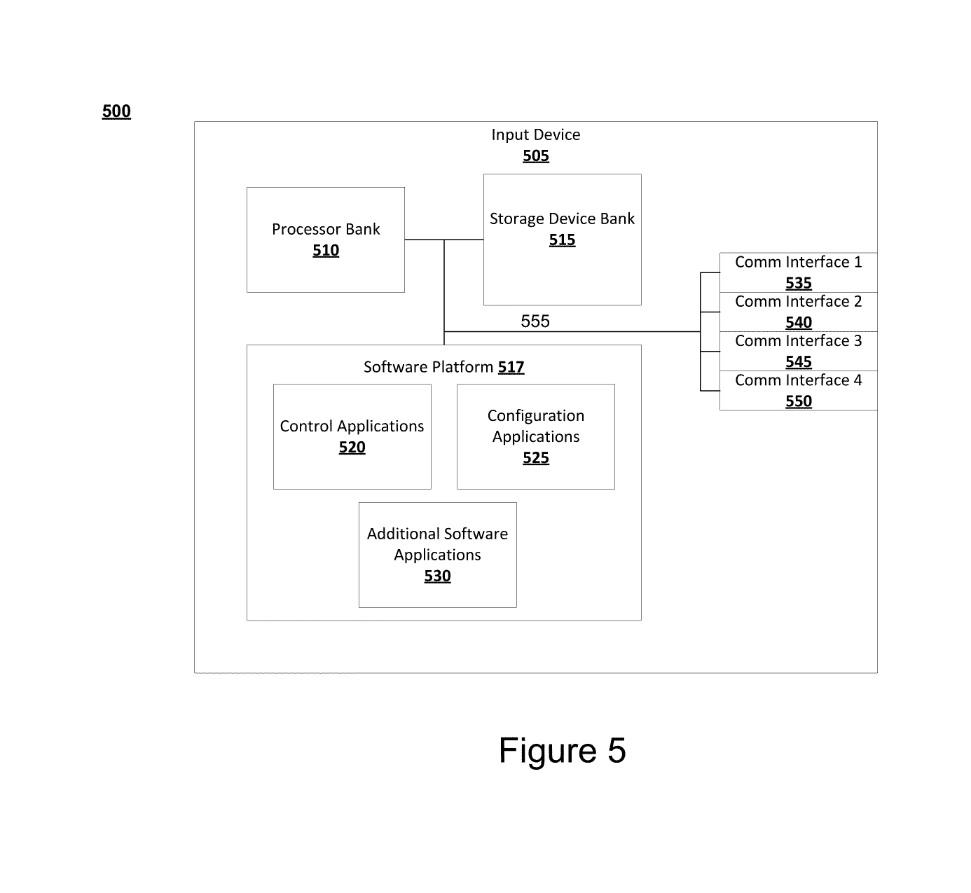

FIG. 5 is an exemplary functional block diagram of an exemplary input device used for integrated searching and retrieving Internet or digital content across a communication network for an exemplary MM system as shown in FIG. 1 and FIG. 2. Such an input device may be a remote control such as for a television or set-top box, mouse, touch screen, keyboard, or a smartphone. The input device 505 may include several different components such as a processor bank 510, storage device bank 515, one or more software applications 517, and one or more communication interfaces (535-550). The processor bank 510 may include one or more processors that may be co-located with each other or may be located in different parts of the input device 505. The storage device bank 515 may include one or more storage devices. Types of storage devices may include memory devices, electronic memory, optical memory, and removable storage media. The one or more software applications 517 may include a control software applications 520, configuration software applications 525, and additional software applications 530. The control software applications 525 may implement software functions that assist in performing certain tasks for the input device 505 such as providing access to a communication network, executing an operating system, managing software drivers for peripheral components, and processing information. Also, the control software applications 525 may include an operating system supported by the input device. Such operating systems are known in the art for such an input shown in FIG. 2 but may also include computer and smartphone operating systems (e.g. Droid, Windows 7, Linux, Windows Mobile, Symbian, MacOS, etc.). Additional software applications 430 may include software drivers for peripheral components, user interface computer programs, debugging and troubleshooting software tools.

The configuration applications 525 may include a software application that configure the MM system in FIG. 1 and FIG. 2 to search for digital and Internet content stored in the DVR or attached storage devices (networked computer) as well as on the Internet. In one embodiment, a user may use the input device and the configuration applications 525 to preconfigure the MM system to search for related content (e.g. actor) to television content that may be viewed in the future. Another embodiment may have the user to use the input device 505 and the configuration applications to search for related content while viewing television content on the display for the MM system.

In another embodiment the configuration software applications 525 may be used to cause signals (infrared, radio frequency, optical, etc.) to be directed to the display of the MM system in such a way to select an object (face of an actor, article of commerce, etc.) within the content being viewed. The display of the MM system can detect such signals from the input device to determine the object selected by the user of the input device. In a further embodiment, the input device may incorporate voice recognition technology such that the user may identify an object with the television content through speech (e.g. car in scene) and convert the speech to text and provide such text to components of the MM system (e.g. content identification engine) to identify the object (e.g. 2011 Porsche 911).

Each of the communication interfaces (535-550) shown in FIG. 5 may be software or hardware associated in communicating to other devices. The communication interfaces (535-550) may be of different types that include a user interface, USB, Ethernet, WiFi, WiMax, wireless, optical, cellular, infrared or any other type of communication interface known in the art coupled to communication network.

An intra-device communication link 555 between the processor bank 510, storage device bank 515, software applications 517, and communication interfaces (535-550) may be one of several types that include a bus or other communication mechanism.

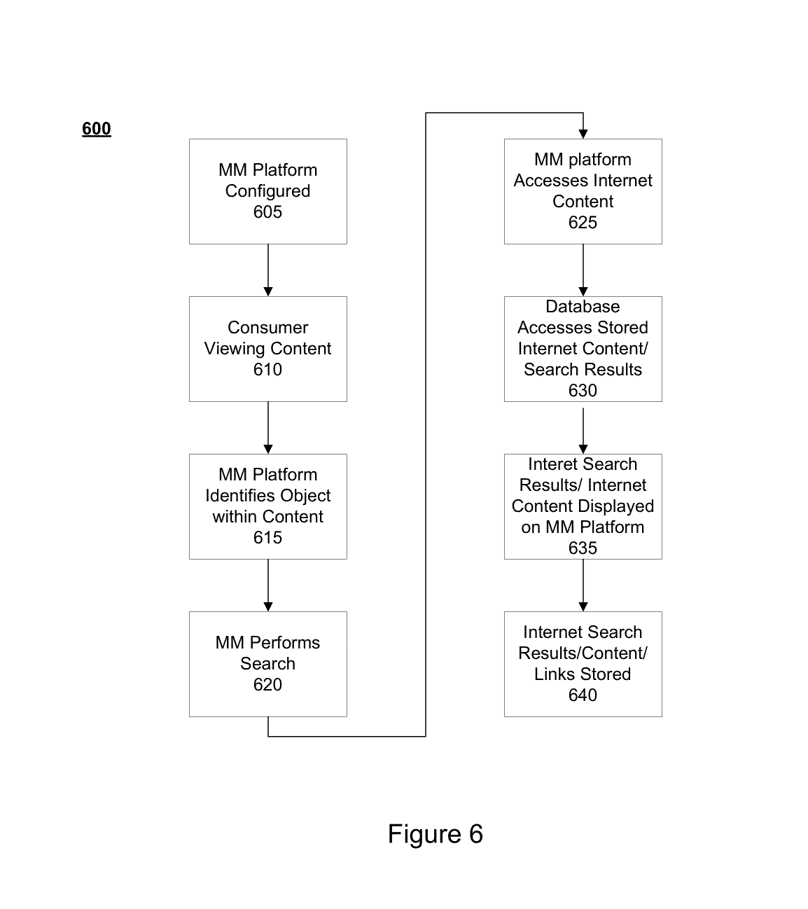

FIG. 6 is an exemplary flowchart 600 showing an example method for integrated searching and retrieving Internet or digital content across a communication network for an exemplary MM system as shown in FIG. 1 and FIG. 2. A step in the exemplary method may include a MM system or platform configured to perform an Internet search or access Internet/digital content before or during viewing any television content, as shown in block 605. The MM system may include different software applications residing on different hardware components that allows a consumer to view more than one types of media (e.g. television content, Internet content, digital content, DVD, blu-ray disc, or any other type of media, etc.). Such systems may include a television coupled to a computer or one or more computing devices as well as a digital video recorder (DVR) and/or other types of storage devices. Further, the MM system may have an underlying operation system (e.g. Android) that controls and operates one or more software and/or hardware components of the MM system. In addition, the components inside a consumer's residence may be coupled over a communication network to one or more computer servers and databases at a remote site. In addition, the consumer may have additional devices coupled to the MM system such as DVD or blu-ray disc players, gaming systems, table (tablet or table), desktop, or laptop computers, as well as smartphones or other mobile devices.

An additional step in the exemplary method may be a consumer viewing content such as a television program, as shown in block 610. In another step, the MM system identifies an object (actor, article of commerce, title of content, etc.) the television content using one or more software applications, as shown in block 615. Based on the previously configured instructions or through indication by an input device by the consumer/user (e.g. remote control push button click, keyboard, voice activation, gesture activation, etc.), identifies the object and instructs the MM system to perform a search relating to identified object within the currently viewed television program, as shown in block 620. Alternate embodiments may include the MM system accessing Internet content or other digital content relating to the television program using similar consumer indication as described above (e.g. remote control push button click, keyboard, voice activation, gesture activation, etc.). For example, the television content may be an on-demand movie with a certain actor. The Internet/digital content accessed may be a related trailer for his upcoming movie. The MM system may access one or more databases or computer servers to retrieve the Internet/digital content or results from Internet searches, as shown in block 630. The Internet and one or more storage devices or databases may be called information repositories. The Internet search results may be stored from previous searches relating to the same television content. Once retrieving the Internet Search results and/or the Internet/digital content, the MM system may display such content on the screen of the MM system, as shown block 635. Another step in the exemplary method may be that the Internet search results and/or Internet/digital content may be stored for later viewing by the consumer in a DVR or any other local storage device, as shown in block 640.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can, of course vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for searching and retrieving content across a communication network using a multimedia system, comprising;
configuring the multimedia system to search for related content during the display of viewed content;
displaying the viewed content on the multimedia system;
identifying one or more objects in the viewed content using one or more software applications implemented by the multimedia system;
searching one or more information repositories for the related content based on the one or more objects;
accessing the related content from the one or more information repositories;
displaying the related content on the multimedia system;

2. The method of claim 1, further comprising storing the related content in one or more storage devices.

3. The method of claim 1, wherein the configuring of the multimedia system is performed using an input device.

4. The method of claim 1, wherein the one or more objects is selected from a group consisting of the title of the viewed content, one or more actors in the viewed content, one or more products in the viewed content, or one or more articles of commerce in the viewed content.

5. The method of claim 1, further comprising configuring the multimedia system to search for related content prior to the display of viewed content.

6. The method of claim 1, wherein the related content is selected from the group consisting of digital content and Internet search results.

7. The method of claim 1 wherein the input device is selected from the group consisting of remote control, keyboard, mouse, voice activation, gesture activation, or smartphone.

8. A multimedia system for searching and retrieving content across a communication network, comprising:
one or more display components;
one or more input receivers;
a multimedia processing unit coupled to the one or more display components and to the one or more input receivers, a multimedia processing unit including:
one or more processors;
one or more storage devices coupled to the one or more processors;
one or more communication interfaces, a first communication interface coupled to the one or more processors and a second communication interface coupled to the communication network;
one or more software applications that: (i) receive configuration information for the multimedia system to search for related content during the display of viewed content using the one or more input receivers; (ii) cause the viewed content to be displayed on the one or more display components; (iii) identify one or more objects in the viewed content; (iv) search one or more information repositories for the related content based on the one or more objects; (v) access the related content from the one or more information repositories; (vi) cause to display the related content on the multimedia system.

9. The system of claim 8, further comprising one or more digital storage devices wherein the one or more software applications store the related content in the one or more digital storage devices.

10. The system of claim 8, further comprising one or more user interfaces to receive the configuration information for the multimedia system.

11. The system of claim 8, wherein the one or more objects is selected from a group consisting of the title of the viewed content, one or more actors in the viewed content, or one or more products in the viewed content.

12. The system of claim 8, wherein the configuration information is provided to the multimedia system prior to the display of viewed content.

13. The system of claim 8, wherein the related content is selected from the group consisting of digital content and Internet search results.

14. The system of claim 10, wherein the one or more input receivers are capable of receiving user input from an input method selected from the group consisting of remote control, keyboard, mouse, voice activation, gesture activation, and smartphone.

15. A multimedia system for searching and retrieving content across a communication network, comprising:
a communication network;
one or more remote computer servers coupled to the communication network;
an input device;
the multimedia system having a multimedia processing unit coupled to one or more display components and to one or more input receivers, a multimedia processing unit including:
one or more processors;
one or more storage devices coupled to the one or more processors;
one or more communication interfaces, a first communication interface coupled to the one or more processors and a second communication interface coupled to the communication network;
one or more software applications that: (i) receive configuration information for the multimedia system to search for related content during the display of viewed content from the input device; (ii) cause the viewed content to be displayed on the one or more display components; (iii) identify one or more objects in the viewed content; (iv) search one or more information repositories for related content based on the one or more objects; (v) access the related content from the one or more information repositories; (vi) cause to display the related content on the multimedia system.

16. The system of claim 15, wherein the one or more remote computer servers is selected from the group consisting of a search engine server, a web server, a content server, and an e-commerce server.

17. The system of claim 14, further comprising one or more digital storage devices wherein the one or more software applications store the related content in the one or more digital storage devices.

18. The system of claim 14, wherein the configuration information is provided to the multimedia system prior to the display of viewed content.

19. The system of claim 14, wherein the related content is selected from the group consisting of digital content, Internet search results, and e-commerce transaction form.

20. The system of claim 14, wherein the one or more input receivers are capable of receiving user input from an input method selected from the group consisting of remote control, keyboard, mouse, voice activation, gesture activation, and smartphone.
